(19) United States
(12) Patent Application Publication
(10) Pub. No.: US 2002/0041145 A1
(43) Pub. Date: Apr. 11, 2002

(54) Phosphor excited by vacuum ultraviolet ray and light emitting apparatus using thereof

(75) Inventors: Nobuyuki Yokosawa, Fujieda-shi (JP); Futoshi Yoshimura, Shizuoka-ken (JP)

Correspondence Address: Richard L. Schwaab, FOLEY & LARDNER, Washington Harbour, 3000 K Street, N.W., Suite 500, Washington, DC, 20007-5109, US

(73) Assignee: KABUSHIKI KAISHA TOSHIBA

(21) Appl. No.: 09/813,880

(22) Filed: Mar. 22, 2001

(30) Foreign Application Priority Data
Mar. 23, 2000 (JP) P2000-82061

(51) Int. Cl. H01J 1/62; H01J 63/04

(52) U.S. Cl. 313/486; 313/485

(57) ABSTRACT

A phosphor excited by a vacuum ultraviolet ray has composition substantially expressed by L₁₋ₓTbₓAl₃(BO₃)₄, or L_{1-x-y}TbₓCe_{y}Al₃(BO₃)₄ (L denotes at least one of element selected from Y and Gd, 0.1<x≦0.7, and 0.00001≦y≦0.01). The phosphor excited by a vacuum ultraviolet ray emits a strong green emission when irradiated with the vacuum ultraviolet ray of 200 nm or less in wavelength, and suitably applied to a light emitting apparatus such as a rare gas discharge lamp or a PDP using a vacuum ultraviolet ray as an exciting source.

### BACKGROUND OF THE INVENTION

1. Field of the Invention

The present invention relates to a green light emitting phosphor excited by a vacuum ultraviolet ray and a light emitting apparatus using thereof.

2. Description of the Related Art

In recent years, a light emitting apparatus using a vacuum ultraviolet ray having a short wave length (for instance, 200 nm or less in wavelength) radiated by a rare gas discharge as an excitation source of a phosphor has been developed. In such a light emitting apparatus, a phosphor emitting light excited by a vacuum ultraviolet ray as an excitation source, namely a phosphor excited by a vacuum ultraviolet ray, is used.

A light emitting apparatus using a vacuum ultraviolet ray as an excitation source is used as, for instance, a display image apparatus. As such a display image apparatus, a plasma display panel (PDP) is known. As oncoming of a multimedia era, a display image apparatus to be a core device of a digital network is required to be large in size, thin in width, and capable of a digital display. The plasma display device has such a property. That is to say, the PDP has a capability of displaying a variety of information in fine with a high definition, and it receives attention as a digital display device capable of being large in size and thin in width.

As for a light emitting apparatus using a vacuum ultraviolet ray as an excitation source, besides a display image apparatus, a rare gas discharge lamp utilizing light emission by discharge with a rare gas such as xenon is known. A rare gas discharge lamp is applied to, for instance, a back light of an in-car liquid crystal display etc. as a typical usage for which safety and the like are required. The rare gas discharge lamp is used in place of a conventional mercury (Hg) discharge lamp. The rare gas discharge lamp receives attention as an excellent discharge lamp in environmental safety because it does not use hazardous mercury.

What is common among the above-described vacuum ultraviolet ray excitation type light emitting apparatus is that they use a vacuum ultraviolet ray having wave lengths of 147 nm or 172 nm radiated by a rare gas discharge in place of a conventional electron ray or ultraviolet ray (wave length: 254.7 nm) obtained from mercury. Since studies on light-emission of a phosphor in a vacuum ultraviolet region are few, the one relatively excellent in light emission property by a vacuum ultraviolet ray is used through empirical selection among conventionally known phosphors, for a vacuum ultraviolet ray excitation type light emitting apparatus.

For instance, in order to realize a full color display with a PDP, phosphor which emits light in each color of red, green, and blue is required. Accordingly, in a conventional full color PDP, (Y, Gd) BO₃:Eu phosphor, as a red light emitting phosphor; Zn₂SiO₄:Mn phosphor, as a green light emitting phosphor; and BaMgAl₁₀O₁₇:Eu phosphor, as a blue light emitting phosphor; etc. are used. A mixture of the above-described light emitting phosphors in each color is usually used in a rare gas discharge lamp.

Further, a manganese activated alkali-earth aluminate phosphor such as (Ba, Sr) Al₁₂O₁₉:Mn, or (Ba, Sr) MgAl₁₄O₂₃:Mn is known as a green light emitting phosphor for the vacuum ultraviolet ray excitation. In the Japanese Patent Laid-open No. Hei 10-1666, as a green light emitting phosphor for the vacuum ultraviolet ray excitation, mentioned is a manganese activated aluminate phosphor which is prepared by solid solution treatment of (Ba, Sr) MgAl₁₀O₁₇:Mn and (Ba, Sr) O. 6Al₂O₃ in a predetermined ratio.

Furthermore, in the Japanese Patent Laid-open Application No. HEI 7-3261, as a green light emitting phosphor for the vacuum ultraviolet ray excitation having a wavelength of 147 nm by a rare gas discharge, mentioned is a terbium activated rare-earth borate phosphor expressed by a (R₁₋ₓ, Tbₓ)₂O₃ bB₂O₃ (R comprises at least one of element selected from Y, La, and Gd, where 0.06≦x≦0.12, and 0≦b/a≦1.3). In the Japanese Patent Laid-open No. Hei 11-71581, mentioned is a terbium activated rare-earth borate phosphor expressed by (Y_{1-x-y}, Gdₓ, Tb_{y})₂O₃.B₂O₃(0.08≦x≦0.8, 0.05≦y≦0.25, and 0.13≦x+y≦1.0). All of these rare-earth borate phosphors have cubic system crystal structures.

In order to realize a light emitting apparatus having high luminance in the above-described PDP or rare gas discharge lamp, it is necessary to enhance the light emitting efficiency in each color of red, green and blue. That is, when light emitting phosphors in each color of red, green, and blue are excited by a vacuum ultra violet ray having a wavelength of 147 nm or 172 nm, it is absolutely necessary to emit light in a high degree of efficiency. In particular, in order to improve luminance in white, it is necessary to enhance the light emitting efficiency by vacuum ultraviolet ray excitation of a green light emitting phosphor having a high luminosity.

However, a sufficient light emitting efficiency has not been obtained with a conventional green light emitting phosphor for vacuum ultraviolet ray excitation, further improvement of the light emitting efficiency of a green light emitting phosphor is strongly required. The manganese activated aluminate phosphor or terbium activated rare-earth borate phosphor described above is a substance to obtain high luminance of the green light emitting phosphor by a vacuum ultraviolet ray. However, sufficient light emitting efficiency is not necessarily obtained. In order to realize high luminance of a light emitting apparatus, required is a green light emitting phosphor having more higher light emitting efficiency when excited by a vacuum ultraviolet ray.

Since the rare gas discharge lamp uses a mixture of phosphors in three colors, the light emitting efficiency (luminance) by vacuum ultraviolet ray excitation becomes more important than the chromaticity as a green light emission. As described above, it is strongly desired to enhance the light emitting efficiency excited by a vacuum ultraviolet ray to a green light emitting phosphor used for a rare gas discharge lamp.

### SUMMARY OF THE INVENTION

Accordingly, an object of the present invention is to provide a vacuum ultraviolet ray excitation phosphor having more improved green light emitting efficiency when excited by a vacuum ultraviolet ray having a wavelength of 200 nm or less. Another object of the present invention is to provide a light emitting apparatus having high luminance by using such a green light emitting vacuum ultraviolet ray excitation phosphor.

In order to achieve the above-described object, inventors of the present invention studied hard on various phosphors and found that the terbium activated rare-earth•aluminum borate phosphor thereto absorbs a vacuum ultraviolet ray efficiently, and found that the Tb to serve as an activator can be contained in relatively high concentration, which makes it excellent in light emission (luminance) efficiency of a green light. They also found that the light emitting (luminance) efficiency can be further improved by adding a very small quantity of Ce to the terbium activated rare-earth•aluminum borate phosphor.

The present invention has been completed on the basis of these findings. A first phosphor excited by a vacuum ultraviolet ray of the present invention is provided with a green light emitting phosphor when excited by a vacuum ultraviolet ray, which consists essentially of a composition expressed by

a general formula: L₁₋ₓTbₓAl₃(BO₃)₄.

(In the formula, L denotes at least one of element selected from Y and Gd, and x is a number satisfying 0.1<x≦0.7).

A second phosphor excited by a vacuum ultraviolet ray consists essentially of a composition expressed by

a general formula: L_{1-x-y}TbₓCe_{y}A₃ (BO₃)₄

(In the formula, L denotes at least one of element selected from Y and Gd, and x and y are numbers satisfying 0.1<x≦0.7, and 0.00001≦y≦0.01).

In the first and second phosphors excited by a vacuum ultraviolet ray of the present invention, the value x showing the content of Tb is especially preferable to be in the range of 0.2≦x≦0.6. The L element may be either Y or Gd alone, or, it may be a mixture of these elements. It is especially preferable that 50 atomic percent or more of the L element is comprised of Gd. The phosphor excited by a vacuum ultraviolet ray according of the present invention is suitable for a green light emitting phosphor for a rare gas discharge lamp.

The light emitting apparatus of the present invention is provided with the phosphor excited by a vacuum ultraviolet ray according to the present invention described above. As a concrete embodiment of the light emitting apparatus of the present invention, what can be listed is a rare gas discharge lamp or a plasma display panel (PDP).

The rare gas discharge lamp comprises a light emitting layer containing a mixture of a green light emitting phosphor excited by a vacuum ultraviolet ray of the present invention, a blue light emitting phosphor and a red light emitting phosphor; and a means for irradiating the light emitting layer with a vacuum ultraviolet ray.

The plasma display panel (PDP) comprises a light emitting layer having a green light emitting phosphor excited by a vacuum ultraviolet ray of the present invention, a blue light emitting phosphor and a red light emitting phosphor; and a means for irradiating the light emitting layer with a vacuum ultraviolet ray.

### BRIEF DESCRIPTION OF THE DRAWINGS

FIG. 1A and FIG. 1B are views showing a structure of a first embodiment when a light emitting apparatus of the present invention is applied to a rare gas discharge lamp; and

FIG. 2 is a view showing a principal structure of a second embodiment when a light emitting apparatus of the present invention is applied to a plasma display panel (PDP).

### DESCRIPTION OF THE PREFERRED EMBODIMENTS

The preferred embodiments to carry out the present invention will be explained below.

A phosphor excited by a vacuum ultraviolet ray of the present invention is a phosphor which emits a green light when irradiated with a vacuum ultraviolet ray, and comprises a composition substantially expressed by

a general formula: L₁₋ₓTbₓAl₃(BO₃)₄ (1)

(In the formula, L denotes at least one of element selected from Y and Gd, and x is a number satisfying 0.1<x≦0.7).

It should be noted that the vacuum ultraviolet ray in the present invention is an ultraviolet ray having a short wavelength of, for instance, 200 nm or less. Such a vacuum ultraviolet ray is radiated by electric discharge using a rare gas such as Xe gas, Xe—Ne gas, and Xe—He gas. Practically, a vacuum ultraviolet ray of 147 nm in wavelength or 172 nm in wavelength is used.

In the vacuum ultraviolet ray excitation phosphor according to the present invention, L element, aluminum (Al), boron (B), and oxygen (O) are elements forming rare-earth•aluminum borate (LAl₃(BO₃)₄) which is a host of the phosphor. Among them, the element L can be either Y or G alone, or can be a mixture thereof. In order to further improve the light emitting efficiency of the phosphor excited by a vacuum ultraviolet ray, at least one part of the element L is preferably comprised of Gd.

The phosphor containing Gd as at least one part of the L element is expressed by

a general formula: (Gd₁₋ₐ, Yₐ)₁₋ₓTbₓAl₃(BO₃)₄ (2)

(In the formula, a and x are numbers satisfying 0≦a<1, and 0.1<x≦0.7).

The value a in the formula (2) is more preferably in the range of 0≦a≦0.5. Namely, it is preferable that more than 50 atomic % of the L element is comprised of Gd. It is desirable that Gd accounts for more than 70 atomic % of the L element.

The phosphor excited by a vacuum ultraviolet ray according to the present invention comprises rare-earth•aluminum borate (LAl₃(BO₃)₄) having a rhombohedral system crystal structure as a host of the phosphor, and a suitable amount of terbium (Tb) contained thereof. A part of the L element is replaced by Tb which serves as an emitting light center. With such a phosphor excited by a vacuum ultraviolet ray, a green light emission in high luminance can be obtained when a vacuum ultraviolet ray is irradiated.

Namely, in the phosphor excited by a vacuum ultraviolet ray, a green light emission can be obtained in a manner that a compound (silicate, aluminate, borate, etc.) as a host of the phosphor absorbs the vacuum ultraviolet ray and this vacuum ultraviolet ray absorbed in the host of the phosphor allows an activator (such as Mn or Tb) to emit light. In such a light emitting system, since a conventional Mn activated silicate phosphor, a Mn activated aluminate phosphor, and a Tb activated rare-earth borate phosphor are insufficient in absorption efficiency of the vacuum ultraviolet ray in the host of the phosphor, the irradiated vacuum ultraviolet ray can not be utilized efficiently.

For instance, a Tb activated rare-earth borate phosphor such as (Y, Gd) BO₃:Tb phosphor etc. uses cubic system rare-earth borate as a host of the phosphor. Such a host of the phosphor is insufficient in absorption efficiency of the vacuum ultraviolet ray, and the content of Tb serving as an activator can not be sufficiently increased. As described above, the Tb activated rare-earth borate phosphor can not sufficiently enhance the light emitting efficiency of green light emission when a vacuum ultraviolet ray is irradiated.

In the meanwhile, a Tb activated rare-earth•aluminum borate phosphor (L₁₋ₓAl₃(BO₃)₄:Tbₓ) can utilize the irradiated vacuum ultraviolet ray efficiently, because the rare-earth•aluminum borate as the host of the phosphor has a rhombohedral system crystal structure and is excellent in absorption efficiency of the vacuum ultraviolet ray. Furthermore, with a rare-earth•aluminum borate, the replacement amount of the L element by Tb can be set high. Based on the above, with the phosphor excited by a vacuum ultraviolet ray according to the present invention, the light emitting efficiency of green light emission (emission due to Tb) can be improved as compared with a conventional green emitting phosphor.

In the phosphor excited by a vacuum ultraviolet ray of the present invention, the content of Tb which serves as an activator is determined as of the value x to be 0.1 over and 0.7 or less. When the value x is 0.1 or less, the light emitting efficiency is decreased. On the other hand, when the value x exceeds 0.7, the concentration quench is occurred. In other words, when the value x is determined in 0.1 over and 0.7 or less, it becomes possible to obtain high luminance green light emission when excited by a vacuum ultraviolet ray.

In particular, in order to enhance the luminance of green light emission when excited by a vacuum ultraviolet ray, the value x denoting the Tb content is preferably in the range of 0.2≦x≦0.6. When a phosphor excited by a vacuum ultraviolet ray in which a rare-earth•aluminum borate is a host of the phosphor is used, the L element can be replaced by Tb to the extent of 60% while maintaining the crystal structure of the host of the phosphor satisfactory. By replacing 20% or more of the element L by Tb, a green light emission in high luminance can be obtained. It is more preferable to determine the content of Tb in the range of 0.2≦x≦0.5.

Moreover, the phosphor excited by a vacuum ultraviolet ray of the present invention has an advantage of a short decay time as compared with a Zn₂SiO₄:Mn phosphor which is a conventional green light emitting phosphor excited by a vacuum ultraviolet ray. The term “decay time” means the passage of time till the light emission is attenuated after irradiation of a vacuum ultraviolet ray is blocked. Concretely, it shows the passage of time till the luminance becomes less than one tenth of luminance at the time of irradiation, after blocking of the vacuum ultraviolet ray. By shortening the decay time of the phosphor excited by a vacuum ultraviolet ray, in the display image apparatus for instance, it becomes possible to improve the dynamic picture characteristic.

The phosphor excited by a vacuum ultraviolet ray may contain a very small amount of cerium (Ce) as a co-activator in addition to the activating agent terbium (Tb). By adding Tb and Ce to a rare-earth•aluminum borate, the light emitting efficiency of the green light emission when irradiated with a vacuum ultraviolet ray can be further enhanced.

The phosphor excited by a vacuum ultraviolet ray using Ce as a co-activating agent, is substantially expressed by

a general formula: L_{1-x-y}TbₓCe_{y}Al₃(BO₃)₄ (3)

(In the formula, x and y are numbers satisfying 0.1<x≦0.7, and 0.000≦y≦0.01). The amount of Ce addition, as expressed by the value of y in the above-described formula (3), is preferably in the range of 0.00001 to 0.01. When the value of y exceeds 0.01, there is a possibility of lowering the light emitting efficiency. Though the lower limit value of y is not always to be confined, in order to obtain the addition effect of Ce effectively, the lower limit value of y is preferable confined to be 0.00001 or more. It should be noted that the conditions except that of Ce is the same as described before.

The phosphor excited by a vacuum ultraviolet ray according to the present invention emits a green light with a value of x in the range of 0.28 to 0.34, and a value of y in the range of 0.57 to 0.60 in CIE chromaticity value (x, y), when irradiated with a vacuum ultraviolet ray of 200 nm or less in wavelength (for instance, a vacuum ultraviolet ray of 147 nm in wavelength). The more preferable CIE chromaticity values (x, y) for the green light emission are in the range of 0.30 to 0.32 for the value of x, and in the range of 0.58 to 0.60 for the value of y.

Though the phosphor excited by a vacuum ultraviolet ray according to the present invention is a little inferior in emission chromaticity as compared with a conventional green light emitting phosphor excited by a vacuum ultraviolet ray, it is useful for the usage when a green light emission in high luminance is required. The phosphor excited by a vacuum ultraviolet ray according to the present invention is suitable for a green light emitting phosphor which is used by mixing with blue and red light emitting phosphors excited by a vacuum ultraviolet ray, for a rare gas discharge lamp.

The phosphor excited by a vacuum ultraviolet ray according to the present invention is manufactured, for instance, as below.

First, oxides of Y, Gd, Tb, Al and B, or hydrate compound or carbonate compound which becomes oxide easily at an elevated temperature, and, as required, compound such as Ce oxide, Ce hydrate, or Ce carbonate are used as respective raw materials. Powders of each raw material described above are weighed to a predetermined quantity so as to obtain the composition described in the formula (1) or formula (3), and mixed completely with flux such as barium fluoride, aluminum fluoride, or magnesium fluoride, using a ball mill etc.

Next, the above-described raw material mixture is taken in a heat-resistant receptacle such as an alumina crucible etc. and burned at 950° C. to 1100° C. for 3 to 5 hours in the atmosphere (primary burning). After pulverizing and sifting thus obtained burned product, it is taken in a heat-resistant receptacle such as an alumina crucible etc. again, and then a supplementary reducing agent such as graphite etc. is placed on it and it is covered with a lid. Under this condition, it is burned at 950° C. to 1100° C. for 3 to 5 hours in a reducing atmosphere such as a forming gas (N₂+H₂) (secondary burning). The secondary burning is effective for improvement of the luminance.

After that, by carrying out respective treatment of dispersing, washing, drying, and sifting as needed, the objective Tb activated (or Tb and Ce activated) rare earth•aluminum borate phosphor, namely a green light emitting phosphor excited by a vacuum ultraviolet ray of the present invention can be obtained.

The phosphor excited by a vacuum ultraviolet ray (green light emitting phosphor) according to the present invention is used for a light emitting apparatus in which a vacuum ultraviolet ray of wave length 147 nm or 172 nm is an excitation source of the phosphor. Namely, the light emitting apparatus of the present invention is provided with a green light emitting phosphor excited by a vacuum ultraviolet ray of the present invention. Concrete examples of the light emitting apparatus are a rare gas discharge lamp and a plasma display panel (PDP) and the like.

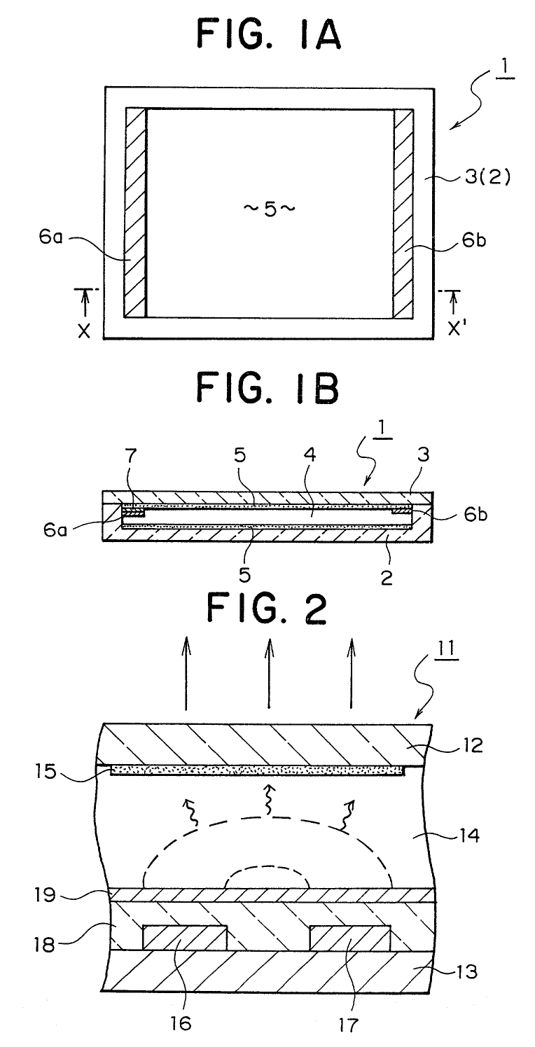

FIG. 1A and FIG. 1B show a structure of a first embodiment when a light emitting apparatus of the present invention is applied to a rare gas discharge lamp. FIG. 1A is a plane view of a flat type rare gas discharge lamp 1. FIG. 1B is a cross-sectional view along the line X-X′ in FIG. 1A.

The flat type rare gas discharge lamp 1 shown in FIG. 1A and FIG. 1B is provided with an air-tight receptacle consisting of a rear face side glass receptacle 2 and a front face side glass plate 3. On the rear face side glass receptacle 2 and the front face side glass plate 3, phosphor layers 5 and 5 are formed respectively as light emitting layers.

The phosphor layer 5 contains the green light emitting phosphor excited by a vacuum ultraviolet ray of the present invention. For instance, the phosphor layer 5 is formed of a phosphor mixture of the green light emitting phosphor excited by a vacuum ultraviolet ray of the present invention with blue and red light emitting phosphors. In this case, for each blue and red emitting phosphor, a variety of well-known phosphors excited by a vacuum ultraviolet ray are used.

A pair of electrodes 6 are provided on the front face glass plate 3 so as to be placed at both ends in the air-tight receptacle 4. Out of the pair of electrodes 6, the first electrode 6a is formed on the phosphor layer 5 through an insulating layer 7. The second electrode 6b is formed directly on the phosphor layer 5. Besides, a rare gas such as Xe gas is filled in the air-tight receptacle 4 and the receptacle is sealed air-tightly under this condition.

In such a flat type Xe discharge lamp 1, a voltage is applied between electrodes 6a and 6b at both ends to create a rare gas discharge. The phosphor layer 5 is excited by a vacuum ultraviolet ray generated by the rare gas discharge. a visible light (for instance, a white light) in response to the structure of the phosphor layer 5 is obtained. Since the green light emitting phosphor excited by a vacuum ultraviolet ray according to the present invention is excellent in light emitting efficiency, it becomes possible to enhance the luminance of an Xe discharge lamp which uses the above-described phosphor.

It should be noted that though FIG. 1 shows an example of a structure of a flat type Xe discharge lamp, but a rare gas discharge lamp using the light emitting apparatus of the present invention is not limited to this example. It is a matter of course that the light emitting apparatus of the present invention is applicable to a Xe discharge lamp in which a phosphor layer is formed on the inside wall surface of an ordinary glass tube (glass valve).

FIG. 2 shows a structure of the second embodiment in which the light emitting apparatus of the present invention is applied to a PDP. In the PDP 11 shown in FIG. 2, a front substrate 12 and a rare substrate 13 formed of a transparent substrate such as a glass substrate are placed face to face with each other through a prescribed space. The space between these substrates 12 and 13 is air-tightly sealed with a sealing member (not shown), thereby forming a discharge space 14.

A phosphor layer 15 as a light emitting layer is formed on the surface of the front substrate 12 on the discharge space 14 side. The phosphor layer 15 comprises a blue light emitting layer, green light emitting layer and red light emitting layer formed in response to pixels. Among light emitting phosphors in respective colors which form the phosphor layer 15, the phosphor excited by the vacuum ultraviolet ray of the present invention is used as a green light emitting phosphor. Incidentally, for each blue and red light emitting phosphor, a variety of well-known blue and red light emitting phosphors excited by a vacuum ultraviolet ray are used.

A large number of striped positive electrodes 16 and negative electrodes 17 are formed in the rare substrate 13. These electrodes 16 and 17 are arranged in matrix. Further, respective electrodes 16 and 17 are covered with a dielectric material layer 18. A protective layer 19 is provided on the surface of the dielectric material layer 18.

A rare gas containing a Xe gas etc. is filled in the discharge space 14 as a discharge medium. It is sealed air-tightly under this condition. As a discharge medium, a mixed gas of, for instance, He gas or Ne gas with several percent of Xe gas is used.

In such a PDP 11, voltage is applied between the positive electrode 16 and the negative electrode 17 to create a rare gas discharge. The phosphor layer 15 is excited by a vacuum ultraviolet ray generated by the rare gas discharge, and a visible light in response to the structure of the phosphor layer 15 is obtained. Since the phosphor layer 15 has a blue light emitting layer, a green light emitting layer, and a red light emitting layer on each pixel, a prescribed color image is displayed.

Since the green light emitting phosphor excited by a vacuum ultraviolet ray of the present invention is excellent in light emitting efficiency, it becomes possible to enhance the luminance of the PDP 11 which uses the phosphor of the present invention. Furthermore, with the PDP 11 using the green light emitting phosphor excited by a vacuum ultraviolet ray of the present invention, voltage at the time of starting the discharge can be reduced.

Incidentally, for a blue and red light emitting phosphors excited by a vacuum ultraviolet ray, a variety of well-known phosphor substances can be used. For instance, as a blue light emitting phosphor excited by a vacuum ultraviolet ray, BaMgAl₁₀O₁₇:Eu phosphor is used. As a red light emitting phosphor excited by a vacuum ultraviolet ray, (Y, Gd) BO₃:Eu phosphor or (Y, Gd)₂O₃:Eu phosphor, etc. is used. However, a blue and red light emitting phosphor n the light emitting apparatus of the present invention are not limited to these, various kinds of phosphors excited by a vacuum ultraviolet ray can be used according to the purpose of the usage.

Next, a concrete example of the present invention and the result of evaluation will be described below.

### EXAMPLE 1

First, for the raw materials of a phosphor, 0.7 mol of Gd₂O₃, 0.15 mol of Tb₄O₇, 3 mol of Al₂O₃, and 8 mol of H₃BO₃ are weighed. After mixing these raw materials completely, they are filled in an alumina crucible, and are burned at 1000° C. for 4 hours in the atmosphere (primary burning).

Next, after pulverizing and sifting this burned product, they are filled in an alumina crucible again and placed a graphite plate on it to cover thereon. In this state, it is burned at 1000° C. at 4 hours in a mixed gas atmosphere of nitrogen and hydrogen (N₂ 97%:H₂ 3% (volume ratio)) (secondary burning). Thus obtained burned product is sifted out to obtain a Tb activated gadolinium•aluminum borate phosphor expressed by a formula Gd_{0.7}Tb_{0.3}Al₃(BO₃)₄. This phosphor is ascertained to have a rhombohedral crystal structure by a X ray diffraction.

Thus obtained Tb activated gadolinium•aluminum borate phosphor is irradiated with a vacuum ultraviolet ray of 147 nm in wavelength to check the luminescence intensity and the luminescence color at that time. The luminescence intensity is obtained as a relative value to the luminance intensity of a conventional green emitting phosphor, Zn₂SiO₄:Mn phosphor (that is Comparative example 1), to be 100. Incidentally, the Zn₂SiO₄:Mn phosphor, (Comparative Example 1) has a hexagonal system crystal structure.

As a result, the luminescence intensity of the Tb activated gadolinium•aluminum borate phosphor in Example 1 is 121%, and the luminescence color is (0.32, 0.59) in CIE chromaticity value (x, y). Thus, it is understood that in the phosphor in Example 1, the luminance of green light emitting excited by a vacuum ultraviolet ray is improved considerably as compared with a conventional phosphor (Comparative Example 1). Furthermore, the decay time is measured, which is the passage of time after the ultraviolet ray is blocked till the luminance becomes less than one tenth of the value at the time of irradiation. The phosphor of Example 1 shows a favorable value of 4 ms while that of the Comparative Example 1 shows 14 ms.

Next, respective Xe discharge lamps are prepared using the Tb activated gadolinium•aluminum borate phosphor of Example 1 and the Zn₂SiO₄:Mn phosphor of Comparative Example 1, and the luminescence intensity and the luminescence color are measured respectively at the time when respective Xe discharge lamps are turned on. As a result, the luminous flux of the Xe discharge lamp using the phosphor in Example 1 is 118%, when the luminous flux of the Xe discharge lamp using the phosphor in Comparative Example 1 is defined to be 100, and the luminescence color (x, y) is (0.31, 0.59). It is understood that the Xe discharge lamp according to Example 1 is substantially increased in luminance as compared with the Xe discharge lamp according to Comparative Example 1.

Furthermore, the PDP shown in FIG. 2 are prepared respectively using the Tb activated gadolinium•aluminum borate phosphor in Example 1 and the Zn₂SiO₄:Mn phosphor in Comparative Example 1, and the luminescence intensity and the luminescence color are measured respectively at the time when respective plasma display panels (DPD) are allowed to emit light. As a result, the luminescence intensity of the PDP using the phosphor in Example 1 is 119%, when the luminescence intensity of the PDP using the phosphor in Comparative Example 1 is defined to be 100, and the luminescence color (x, y) is (0.31, 0.59). It is understood that the PDP according to Example 1 is substantially increased in luminance as compared with the PDP according to Comparative Example 1.

### EXAMPLE 2

For the phosphor materials, 0.8 mol of Gd2O₃, 0.1 mol of Tb₄O₇, 3 mol of Al₂O₃, and 8 mol of H₃BO₃ are weighed. After mixing these raw materials completely, they are treated by a primary burning and a secondary burning, etc. in the same conditions as Example 1 and Tb activated gadolinium•aluminum borate phosphor expressed by Gd_{0.8}Tb_{0.2}Al₃(BO₃)₄ is obtained. This phosphor is ascertained to have a rhombohedral crystal structure by a X ray diffraction.

The luminescence intensity, luminescence color, and decay time at the time when the Tb activated gadolinium•aluminum borate phosphor thus obtained is irradiated by a vacuum ultraviolet ray of 147 nm in wavelength are measured in the same manner as in Example 1. Moreover, the luminescence intensity, and luminescence color of the Xe discharge lamp and the PDP which are prepared using this phosphor are measured in the same manner as in Example 1. These results are shown in Table 1.

### EXAMPLE 3

For the phosphor materials, 0.35 mol of Gd₂O₃, 0.35 mol of Y₂O₃, 0.15 mol of Tb₄O₇, 3 mol of Al₂O₃, and 8 mol of H₃BO₃ are weighed. After mixing these raw materials completely, they are treated by a primary burning and a secondary burning, etc. in the same conditions as Example 1 and Tb activated gadolinium•yttrium•aluminum borate phosphor expressed by Y_{0.35}Gd_{0.35}Tb_{0.3}Al₃(BO₃)₄ is obtained. This phosphor is ascertained to have a rhombohedral crystal structure by a X ray diffraction.

The luminescence intensity, luminescence color, and decay time at the time when the Tb activated gadolinium•yttrium•aluminum borate phosphor thus obtained is irradiated by a vacuum ultraviolet ray of 147 nm in wavelength are measured in the same manner as in Example 1. Moreover, the luminescence intensity, and luminescence color of the Xe discharge lamp and the PDP which are prepared using this phosphor are measured in the same manner as in Example 1. These results are shown in Table 1.

### EXAMPLES 4 TO 8

Except varying the amount of Gd₂O₃ and Y₂O₃ for the raw materials of the host of phosphor, and Tb₄O₇for the raw material of the light emitting center, in the mixture so as to match with each phosphor composition in Table 1, the mixture is treated as in Examples 1 to 3, and each Tb activated rare-earth•aluminum borate phosphor is prepared. These respective phosphors are ascertained to have a rhombohedral crystal structure by a X ray diffraction.

The luminescence intensity, luminescence color, and decay time at the time when each Tb activated rare-earth•aluminum borate phosphor thus obtained is irradiated by a vacuum ultraviolet ray of 147 nm in wavelength are measured in the same manner as in Example 1. Moreover, the luminescence intensity, and luminescence color of the Xe discharge lamps and the PDP which are prepared using these respective phosphor are measured in the same manner as in the Example 1. These results are shown in Table 1.

### COMPARATIVE EXAMPLE 2

Except varying the amount of Y₂O₃for the raw material of the host of the phosphor and Tb₄O₇ for the raw material of the light emitting center in the mixture so as to match with the phosphor composition in Table 1, the mixture is treated as in Examples 1, and Tb activated rare-earth•aluminum borate phosphor is prepared. It should be noted that the amount of Tb content is not within the range of the present invention. This phosphor has a rhombohedral crystal structure.

For the phosphor in this Comparative Example 2, the luminescence intensity, luminescence color, and decay time at the time when irradiated by a vacuum ultraviolet ray are measured in the same manner as in Example 1. Moreover, the luminescence intensity, and luminescence color of the Xe discharge lamp and the PDP which are prepared using this phosphor are measured in the same manner as in Example 1. These results are shown in Table 1.

### COMPARATIVE EXAMPLE 3

As the phosphor materials, 0.9 mol of Y₂O₃, 0.05 mol of Tb₄O₇, and 2 mol of H₃BO₃ are weighed. After mixing these raw materials completely, they are treated by a primary burning and a secondary burning, etc. in the same conditions as Example 1, and a Tb activated yttrium borate phosphor expressed by Y_{0.9}Tb_{0.1}BO₃is obtained. This phosphor is ascertained to have a cubic system crystal structure by a X ray diffraction.

For the phosphor in this Comparative Example 3, the luminescence intensity, luminescence color, and decay time at the time when irradiated by a vacuum ultraviolet ray are measured in the same manner as in Example 1. Moreover, the luminescence intensity, and luminescence color of the Xe discharge lamp and the PDP which are prepared using this phosphor are measured in the same manner as in Example 1. These results are shown in Table 1.

TABLE 1

| | | | | | Xe DISCHARGE | | | |
|---|---|---|---|---|---|---|---|---|
| | | PHOSPHOR | | | LAMP | | PDP | |
| | PHOSPHOR COMPOSITION | (*1) | (*2) | (*3) | (*1) | (*2) | (*1) | (*2) |
| EXAMPLE 1 | Gd_{0.7}Tb_{0.3}Al₃(BO₃)₄ | 121 | 0.32, 0.59 | 4 | 118 | 0.31, 0.59 | 119 | 0.31, 0.59 |
| EXAMPLE 2 | Gd_{0.8}Tb_{0.2}Al₃(BO₃)₄ | 115 | 0.32, 0.59 | 4 | 114 | 0.31, 0.60 | 114 | 0.31, 0.59 |
| EXAMPLE 3 | Y_{0.35}Gd_{0.35}Tb_{0.3}Al₃(BO₃)₄ | 120 | 0.32, 0.59 | 4 | 121 | 0.31, 0.60 | 122 | 0.31, 0.60 |
| EXAMPLE 4 | Y_{0.14}Gd_{0.56}Tb_{0.3}Al₃(BO₃)₄ | 120 | 0.31, 0.58 | 4 | 119 | 0.31, 0.59 | 121 | 0.31, 0.59 |
| EXAMPLE 5 | Y_{0.64}Gd_{0.16}Tb_{0.2}Al₃(BO₃)₄ | 110 | 0.32, 0.59 | 4 | 110 | 0.31, 0.58 | 111 | 0.31, 0.59 |
| EXAMPLE 6 | Gd_{0.5}Tb_{0.5}Al₃(BO₃)₄ | 108 | 0.31, 0.59 | 4 | 108 | 0.31, 0.59 | 109 | 0.31, 0.59 |
| EXAMPLE 7 | Y_{0.56}Gd_{0.14}Tb_{0.3}Al₃(BO₃)₄ | 105 | 0.31, 0.58 | 4 | 106 | 0.31, 0.59 | 105 | 0.31, 0.60 |
| EXAMPLE 8 | Y_{0.7}Tb_{0.3}Al₃(BO₃)₄ | 102 | 0.31, 0.59 | 4 | 102 | 0.32, 0.59 | 102 | 0.31, 0.59 |
| COMPARATIVE | Zn₂SiO₄:Mn | 100 | 0.22, 0.72 | 14 | 100 | 0.22, 0.72 | 100 | 0.21, 0.72 |
| EXAMPLE 1 | | | | | | | | |
| COMPARATIVE | Y_{0.95}Tb_{0.05}Al₃(BO₃)₄ | 90 | 0.31, 0.58 | 4 | 88 | 0.31, 0.58 | 89 | 0.31, 0.58 |
| EXAMPLE 2 | | | | | | | | |
| COMPARATIVE | Y_{0.9}Tb_{0.1}BO₃ | 85 | 0.31, 0.59 | 4 | 86 | 0.32, 0.59 | 86 | 0.31, 0.59 |
| EXAMPLE 3 | | | | | | | | |

*1: LUMINANCE (RELATIVE VALUE)
*2: CHROMATICITY (x, y)
*3: PERSISTENCE TIME (ms)

As is clear from Table 1, it is understood that the Tb activated rare-earth•aluminum borate phosphor is excellent in light emitting efficiency of green light emission when excited by a vacuum ultraviolet ray.

Especially, it is preferable in the point of luminance to use Gd as at least a part of rare-earth element L, and moreover the Gd is contained in the element L in an amount of 50 atomic percent or more.

### EXAMPLE 9

For the phosphor materials, 0.6999 mol of Gd₂O₃, 0.0001 mol of CeO₂, 0.15 mol of Tb₄O₇, 3 mol of Al₂O₃, and 8 mol of H₃BO₃ are weighed. After mixing these raw materials completely, they are treated by a primary burning and a secondary burning, etc. in the same conditions as Example 1 and Tb and Ce activated gadolinium•aluminum borate phosphor expressed by Gd_{0.6999}Ce_{0.0001}Tb_{0.3}Al₃(BO₃)₄ is obtained. This phosphor is ascertained to have a rhombohedral crystal structure by a X ray diffraction.

The luminescence intensity, luminescence color, and decay time at the time when the Tb and Ce activated gadolinium•aluminum borate phosphor thus obtained is irradiated by a vaccume ultraviolet ray are measured in the same manner as in Example 1. Moreover, the luminescence intensity, and luminescence color of the Xe discharge lamp and the PDP which are prepared using this phosphor are measured in the same manner as in Example 1. These results are shown in Table 2.

### EXAMPLE 10 TO 18

Except varying the amount of Gd₂O₃ and Y₂O₃ for the raw materials of the host of the phosphor, Tb₄O₇for the raw material of the light emitting center, and CeO2 for a sensitizing agent in the mixture so as to match the phosphor composition in Table 2, the mixture is treated as in Examples 9, and each Tb and Ce activated rare-earth•aluminum borate phosphor is prepared. These respective phosphors are ascertained to have a rhombohedral crystal structure by a X ray diffraction.

The luminescence intensity, luminescence color, and decay time at the time when the Tb and Ce activated rare-earth•aluminum borate phosphor thus obtained is irradiated by a vaccume ultraviolet ray are measured in the same manner as in Example 1. Moreover, the luminescence intensity and luminescence color of the Xe discharge lamp and the PDP which are prepared using these respective phosphors are measured in the same manner as in Example 1. These results are shown in Table 2.

### COMPARATIVE EXAMPLE 4

Except varying the amount of Gd₂O₃ for the raw material of the host of the phosphor, Tb₄O₇ for the raw material of the light emitting center and CeO2 for a sensitizing agent in the mixture so as to match with the phosphor composition in Table 2, the mixture is treated as in Example 9, and Tb and Ce activated rare-earth•aluminum borate phosphor is prepared. It should be noted that the phosphor has Ce content which is not within the range of the present invention.

For the phosphor in this Comparative Example 4, the luminescence intensity, luminescence color, and decay time at the time when irradiated by a vacuum ultraviolet ray are measured in the same manner as in Example 1. Moreover, the luminescence intensity, and luminescence color of the Xe discharge lamp and the PDP which are prepared using this phosphor are measured in the same manner as in Example 1. These results are shown in Table 2.

TABLE 2

| | | | | | Xe DISCHARGE | | | |
|---|---|---|---|---|---|---|---|---|
| | | PHOSPHOR | | | LAMP | | PDP | |
| | PHOSPHOR COMPOSITION | (*1) | (*2) | (*3) | (*1) | (*2) | (*1) | (*2) |
| EXAMPLE 9 | Gd_{0.6999}Ce_{0.0001}Tb_{0.3}Al₃(BO₃)₄ | 126 | 0.32, 0.59 | 4 | 125 | 0.31, 0.59 | 125 | 0.31, 0.59 |
| EXAMPLE 10 | Gd_{0.699}Ce_{0.001}Tb_{0.2}Al₃(BO₃)₄ | 116 | 0.32, 0.59 | 4 | 116 | 0.31, 0.60 | 116 | 0.31, 0.60 |
| EXAMPLE 11 | Y_{0.6999}Ce_{0.0001}Tb_{0.3}Al₃(BO₃)₄ | 105 | 0.32, 0.59 | 4 | 104 | 0.31, 0.60 | 105 | 0.31, 0.60 |
| EXAMPLE 12 | Gd_{0.7999}Ce_{0.0001}Tb_{0.2}Al₃(BO₃)₄ | 122 | 0.31, 0.58 | 4 | 123 | 0.31, 0.59 | 122 | 0.31, 0.59 |
| EXAMPLE 13 | Y_{0.7999}Ce_{0.0001}Tb_{0.2}Al₃(BO₃)₄ | 112 | 0.32, 0.59 | 4 | 112 | 0.31, 0.58 | 112 | 0.31, 0.58 |
| EXAMPLE 14 | Y_{0.34995}Gd_{0.34995}Ce_{0.0001}Tb_{0.3}Al₃(BO₃)₄ | 122 | 0.31, 0.59 | 4 | 123 | 0.31, 0.59 | 123 | 0.31, 0.58 |
| EXAMPLE 15 | Y_{0.34975}Gd_{0.34975}Ce_{0.0005}Tb_{0.3}Al₃(BO₃)₄ | 121 | 0.31, 0.58 | 4 | 120 | 0.31, 0.59 | 121 | 0.31, 0.59 |
| EXAMPLE 16 | Y_{0.48993}Gd_{0.20997}Ce_{0.0001}Tb_{0.3}Al₃(BO₃)₄ | 116 | 0.31, 0.59 | 4 | 116 | 0.31, 0.59 | 116 | 0.31, 0.58 |
| EXAMPLE 17 | Y_{0.20997}Gd_{0.48993}Ce_{0.0001}Tb_{0.3}Al₃(BO₃)₄ | 122 | 0.31, 0.59 | 4 | 122 | 0.31, 0.59 | 123 | 0.31, 0.58 |
| COMPARATIVE | Zn₂SiO₄:Mn | 100 | 0.22, 0.72 | 4 | 100 | 0.22, 0.72 | 100 | 0.21, 0.72 |
| EXAMPLE 1 | | | | | | | | |
| COMPARATIVE | Y_{0.9}Tb_{0.1}BO₃ | 85 | 0.31, 0.59 | 4 | 86 | 0.32, 0.59 | 86 | 0.32, 0.59 |
| EXAMPLE 3 | | | | | | | | |
| COMPARATIVE | Gd_{0.6}Ce_{0.1}Tb_{0.3}Al₃(BO₃)₄ | 80 | 0.32, 0.59 | 4 | 80 | 0.32, 0.59 | 80 | 0.32, 0.59 |
| EXAMPLE 4 | | | | | | | | |

*1: LUMINANCE(RELATIVE VALUE),
*2: CHROMATICITY, (x, y),
*3: PERSISTENCE TIME(ms)

As is clear from Table 2, it is understood that the Tb and Ce activated rare-earth•aluminum borate phosphor is excellent in light emitting efficiency of green light emission when excited by a vacuum ultraviolet ray.

As is clear from the above-described examples, the light emitting efficiency of green light emission can be enhanced when activated by a vacuum ultraviolet ray of 200 nm or less in wavelength with the light emitting phosphor excited by a vacuum ultraviolet ray according to the present invention. Therefore, by applying this kind of phosphor excited by a vacuum ultraviolet ray to a rare-gas discharge lamp, a PDP and the like, it becomes possible to provide a light emitting apparatus excellent in light emitting efficiency.

What is claimed is:

1. A phosphor excited by a vacuum ultraviolet ray provided with a green light emitting phosphor when excited by the vacuum ultraviolet ray, the phosphor consisting essentially of a composition expressed by
a general formula: L₁₋ₓTbₓAl₃(BO₃)₄
(In the formula, L denotes at least one of element selected from Y and Gd, and x is a number satisfying 0.1<x≦0.7).

2. The phosphor excited by the vacuum ultraviolet ray according to claim 1:
wherein the value of x expressing the content of the Tb satisfies in the range of 0.2≦x≦0.6.

3. The phosphor excited by the vacuum ultraviolet ray according to claim 1:
wherein 50 atomic percent or more of the L element is Gd.

4. The phosphor excited by the vacuum ultraviolet ray according to claim 1:
wherein the phosphor possesses a crystal structure of a rhombohedral system.

5. The phosphor excited by the vacuum ultraviolet ray according to claim 1:
wherein the phosphor emits a green light with a value of x in the range of 0.28 to 0.34, and a value of y in the range of 0.57 to 0.60 in CIE chromaticity value (x, y), when irradiated with the vacuum ultraviolet ray of 200 nm or less in wavelength.

6. The phosphor excited by the vacuum ultraviolet ray according to claim 1:
wherein the phosphor is used as the green light emitting phosphor for a rare gas discharge lamp.

7. The phosphor excited by the vacuum ultraviolet ray according to claim 1:
wherein the phosphor is used as the green light emitting phosphor for a plasma display panel.

8. A phosphor excited by a vacuum ultraviolet ray provided with a green light emitting phosphor when excited by the vacuum ultraviolet ray, the phosphor consisting essentially of a composition expressed by
a general formula: L_{1-x-y}Tbₓ Ce_{y}Al₃(BO₃)₄
(In the formula, L denotes at least one of element selected from Y and Gd, and x and y are numbers satisfying 0.1<x≦0.7, and 0.00001≦y≦0.01).

9. The phosphor excited by the vacuum ultraviolet ray according to claim 8:
wherein the value of x expressing the content of the Tb satisfies in the range of 0.2≦x≦0.6.

10. The phosphor excited by the vacuum ultraviolet ray according to claim 8:
wherein the phosphor possesses a crystal structure of a rhombohedral system.

11. A light emitting apparatus, comprising:
a green light emitting phosphor excited by a vacuum ultraviolet ray according to claim 1.

12. The light emitting apparatus, comprising:
a green light emitting phosphor excited by a vacuum ultraviolet ray according to claim 8.

13. The light emitting apparatus according to claim 11:
wherein the light emitting apparatus includes a rare gas discharge lamp, the rare gas discharge lamp comprising;
a light emitting layer containing a mixture of the green light emitting phosphor excited by the vacuum ultraviolet ray, a blue light emitting phosphor and a red light emitting phosphor, and
means for irradiating the light emitting layer with the vacuum ultraviolet ray.

14. The light emitting apparatus according to claim 11:
wherein the light emitting apparatus includes a plasma display panel, the plasma display panel comprising;
a light emitting layer having the green light emitting phosphor excited by the vacuum ultraviolet ray, a blue light emitting phosphor and a red light emitting phosphor, and
means for irradiating the light emitting layer with the vacuum ultraviolet ray.
